(19) United States
(12) Patent Application Publication
(10) Pub. No.: US 2007/0097955 A1
(43) Pub. Date: May 3, 2007

(54) METHOD AND APPARATUS FOR IP MULTICAST RELAY OF LIVE TV STREAMING TRAFFIC IN A TV-OVER-IP ENVIRONMENT

(75) Inventors: Qiang Li, Campbell, CA (US); Naxin Wang, Cupertino, CA (US); Jiffei Song, Cupertino, CA (US)

Correspondence Address: FELIX L. FISCHER, ATTORNEY AT LAW, 1607 MISSION DRIVE, SUITE 204, SOLVANG, CA, 93463, US

(73) Assignee: UTSTARCOM, INC, Alameda, CA (US)

(21) Appl. No.: 11/163,764

(22) Filed: Oct. 28, 2005

(51) Int. Cl. H04L 12/66

(52) U.S. Cl. 370/352

(57) ABSTRACT

A system for live TV transmission over IP networks incorporates a head end real-time encoding/transcoding server for converting live TV encoded data streams with root multicast relay servers receiving multicast data streams from the encoding/transcoding server. The multicast stream output is provided to a first set of relay servers through multicast capable routers and the root multicast servers provide unicast stream output to a second set of relay servers through unicast limited routers. The first and second sets of relay servers provide unicast and multicast stream output for child servers or local access networks.

### REFERENCE TO RELATED APPLICATIONS

This application is related to copending applications Ser. Nos. 10/826,519 carrying attorney docket no. U001 100084 entitled METHOD AND APPARATUS FOR A LOOSELY COUPLED, SCALABLE DISTRIBUTED MULTIMEDIA STREAMING SYSTEM filed on Apr. 16, 2004 and 10/826,520 entitled METHOD AND APPARATUS FOR MEDIA CONTENT DISTRIBUTION IN A DISTRIBUTED MULTIMEDIA STREAMING SYSTEM carrying attorney docket no. U001 100085 filed on Apr. 16, 2004, both applications having a common assignee with the present application, the contents of which are incorporated herein by reference.

### BACKGROUND OF THE INVENTION—FIELD OF THE INVENTION

This invention relates generally to the field of distributed multimedia streaming and more particularly to distribution of live TV multicast programming using unicast methods to tunnel through network segments without multicast support.

### BACKGROUND OF THE INVENTION—DESCRIPTION OF THE RELATED ART

Broadcast of live TV programming is desirable for TV-over-IP applications. Many networks are enabled for multicast transmission to support direct streaming of the live broadcast. However, for many networks in the infrastructure end-to-end IP multicast from a live TV head-end to the set top box (STB) at the customer premises is not supported. In certain segments of the network routing can only be accomplished by unicast methods. However, for optimized management and efficiency, a centralized live TV head-end is desirable as opposed to introducing live TV multicast through multiple head ends dispersed through the system. Consequently, it is desirable to support unicast IP traffic to tunnel through segments of the network where multicast is not supported to deliver live TV strams from a single head-end to the entire IPTV network.

### SUMMARY OF THE INVENTION

The present invention provides a system for live TV transmission over IP networks which incorporates a head end real-time encoding/transcoding server for converting live TV encoded data streams with root multicast relay servers receiving multicast data streams from the encoding/transcoding server. Multicast stream output is provided to a first set of relay servers through multicast capable routers and the root multicast servers provide unicast stream output to a second set of relay servers through unicast limited routers. The first and second sets of relay servers provide unicast and multicast stream output for child servers or local access networks.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of a network system for multi-media streaming in which the present invention is employed;

FIG. 2 is a diagram network elements having multicast and unicast capability for operation of the present invention; and

FIG. 3 is a flow diagram of the process for operation of a multicast relay server according to the present invention.

### DETAILED DESCRIPTION OF THE INVENTION

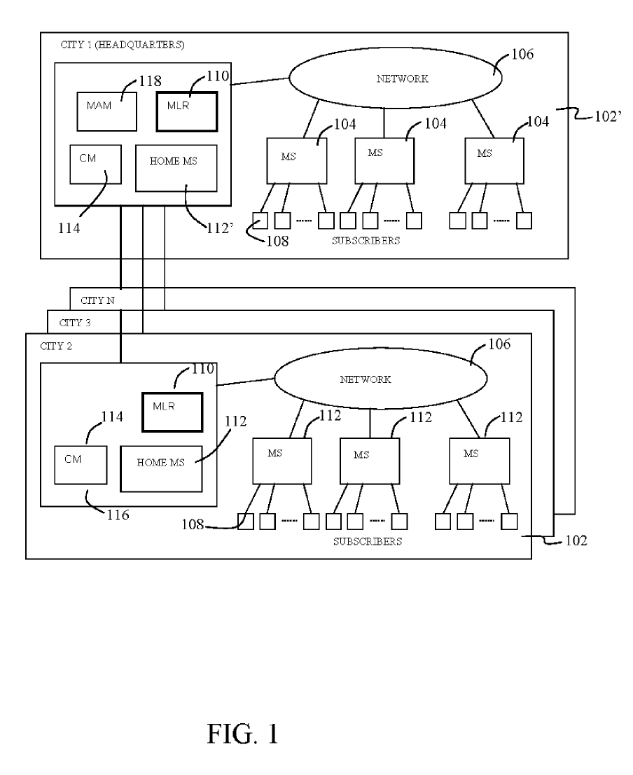

FIG. 1 demonstrates one embodiment of a network system designated a Media Switch with incorporates groups of media stations configured for use in a number of geographical areas or cities 102 served. A complete description of the Media Switch is disclosed in companion application Ser. No. 10/826,520 entitled METHOD AND APPARATUS FOR MEDIA CONTENT DISTRIBUTION IN A DISTRIBUTED MULTIMEDIA STREAMING SYSTEM having a common assignee with the current application, the contents of which are fully incorporated herein by reference. Each city employs a series of media stations 104 interconnected through the metropolitan area network (MAN) 106. Each media station serves a number of subscribers having media consoles or STBs 108. Each subscriber has a primary media station to serve its streaming requests. Additionally, each city incorporates on-line support layer elements including a media location registry (MLR) 110, a home media station 112 and a content manager 114 in a data center (DC) 116. For the embodiment shown, a principal city 102′ is chosen as a headquarters site. Associated with that site is a Media Asset Management (MAM) system 118. In alternative embodiments, multiple cities incorporate a MAM for introduction of content into the system.

The MAM determines when and where to distribute a program. The CM publishes the program at the time specified by the MAM and the MLR identifies the location of the data for distribution.

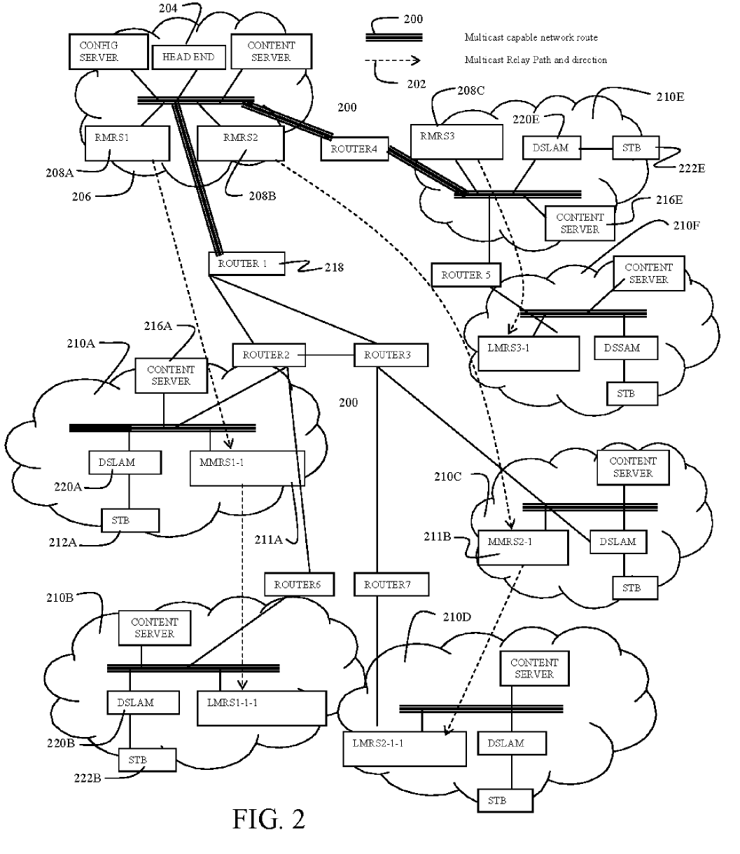

Live TV broadcasts are a subset of the media streaming performed by the Media Switch. Multicast transmission within the MAN or between various cities each having a separate MAN may not be possible where the network connections will not support multicast. FIG. 2 demonstrates the configuration of the overall network in a generalized form and with certain router served segments (designated 200) supporting multicast and other segments having only unicast capability which require relay by unicast (designated 202)

Live TV signals through a real-time encoding/transcoding server 204 are turned into encoded video streams carried by IP multicast traffic in the head-end local network 206. Multiple computer servers form multiple tree topology clusters through the open networks with three servers as the root servers 208a, 208b and 208c (Root Multicast Relay Server 1, 2, 3), that are physically attached to the head-end live TV stream multicast network. Intermediate servers 211a and 211b (Middle Multicast Relay Server 1-1 and 2-1) are present in middle networks 210a, and 210c. The leaf servers 212a, 212b and 212c (Leaf Multicast Relay Server 1-1-1, 2-1-1 and 3-1) in the cluster are attached to the edge access networks.

A centralized configuration server 214, which may be incorporated as a portion of the Network Management System (NMS)] in the Media Switch application, controls the topology of the relay servers. When a relay server boots up, the topology from the configuration server is transmitted and stored in the relay server. Each relay server has the knowledge of its immediate precedent server and its immediate descendant servers in the cluster.

From the configuration server, along with the cluster topology, a relay server also receives the IP addresses and port numbers from which the sourced live TV streams that its precedent server forwards will be received. In addition, a relay server also obtains the IP addresses and port numbers to which it will send the received live TV streams for receipt by its descendant servers.

For segments without multicast capability, the root relay servers (Root Multicast Relay Server 1, 2 and 3) receive the live TV streams from the head-end IP multicast network and send the streams to their immediate descendant servers through unicast IP traffic in areas that multicast IP are not supported.

Each intermediate relay server receives the live TV streams from its immediate precedent server through unicast IP traffic and relays those streams to its immediate descendant servers through unicast IP. Concurrently, the relay server also multicasts out the received live TV streams to the access network it is attached to.

Each leaf relay server receives the live TV streams from its immediate precedent server through unicast IP traffic and multicasts out to the access network to which it is attached. A relay server has the capability to relay multiple streams at the same time with the input stream to the relay server either unicast or multicast depending on the networks that it is connected to. All relay servers provide multicast TV streams to customer premises if the access networks that they are connected to support multicast.

As specific examples referencing FIG. 2, the head-end network 206 incorporates the live TV signals through a Head End real-time encoding/transcoding server 204 which are turned into encoded video streams. These streams are controlled and stored in content server 216. The configuration server communications with all of the servers in the system for topology management. Head end network 206 communicates through routers 218. Router1 handles traffic with a first intermediate network 210a through router2. Each of the intermediate or leaf networks may be a MAN as previously described. Router1 is multicast capable, however, subsequent routers in the network stream, router2 which serves network 210a and router3 which serves a second intermediate network 210b are not multicast capable. Consequently, to service network 210a root multicast relay server 1 (RMRS 1) in the head-end network communicates with middle multicast relay server 1-1 (MMRS 1-1) using unicast IP traffic. MMRS 1-1 then distributes the data to the elements in access network 210a which has internal multicast capability including a content server 216a, which for the embodiment shown employs a media engine and media director as defined in patent application Ser. No. 10/826,519 entitled METHOD AND APPARATUS FOR A LOOSELY COUPLED, SCALABLE DISTRIBUTED MULTIMEDIA STREAMING SYSTEM, for storage of the data streams and DSLAM 220a for communication to a representative STB 222a.

Similarly, router6 which connects leaf network 210b to the system is not multicast capable. However, rather than requiring direct communication with the root multicast relay server to stream data to the network, the configuration server has provided data for communication by leaf multicast relay server 1-1-1 with middle multicast relay server 1-1. MMRS1-1 forwards by unicast IP traffic the broadcast streams to LMRS 1-1-1. LMRS 1-1-1 then transmits the data to the elements of network 210b using the internal multicast capability of the network. Again, an exemplary content server 216b and a DSLAM 220b for communication with STB 222b are shown.

Router3 and router7 similarly support networks 210c and 210d respectively. However, multicast transmission capability is not available. Therefore, unicast transmission must again be employed. In network 210c, MMRS 2-1 receives unicast data from the Root multicast relay server 2 (RMRS 2) 208b in head end network 206. As with MMRS 1-1, MMRS 2-1 distributes the data streams received to its own access network 210c using multicast trafficking and provides unicast transmission to LMRS 2-1-1 in network 210d. LMRS 2-1-1 then distributes the data within its access network by multicast.

Router4 is multicast capable and root multicast relay server 3 receives live TV multicast data directly from the head end. Since RMRS 3 receives the live TV multicast data directly over multicast route, it is designated as a Root Multicast Relay Server even though not located in the head end local network. RMRS 3 then distributes the data to the elements in access network 210e including a content server 216e for storage of the data streams and DSLAM 220e for communication to a representative STB 222e.

Network 210f is also a leaf network since router5 does not support multicast transmission. LMRS3-1 therefore receives unicast data from RMRS3 and then distributes the data as multicast traffic within its access network 210f.

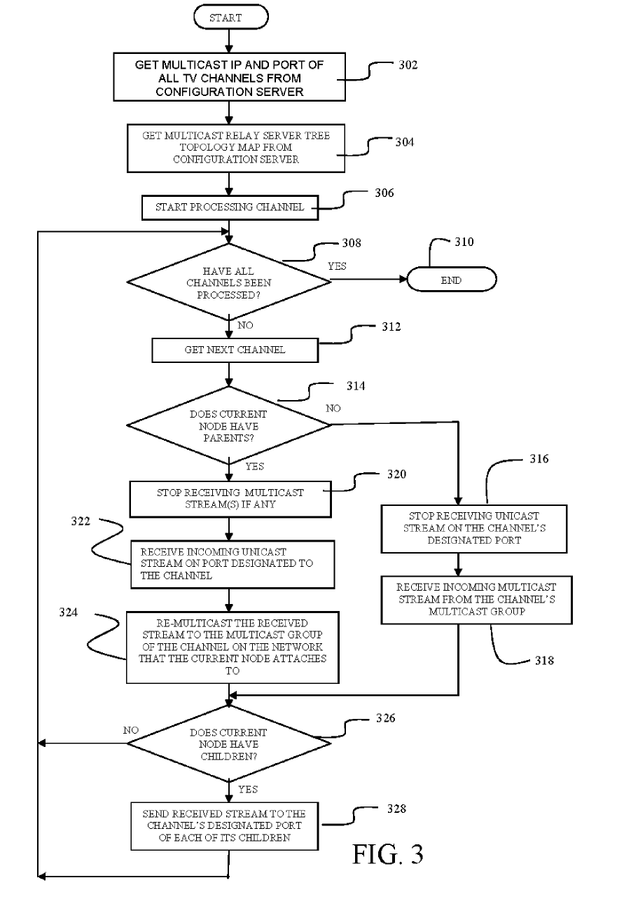

Each multicast relay server in the system has the capability to receive and transmit either multicast or unicast traffic. The designation of root, middle or leaf is determined solely based on the skip level from the head end network. FIG. 3 shows the communication sequence for the relay servers in the network. On boot-up, the relay server obtains the multicast IP and Port of all TV channels from the configuration server 302. Additionally, the multicast relay server tree topology map is obtained from the configuration server to establish parent relay servers from which communications are received and child relay servers to which communications are forwarded 304.

The relay server starts processing the channels 306 based on the data received from the configuration server. A determination is made 308 if all channels have been processed. If so, the relay server stops processing 310 until new configuration data is received. If not, the data for the next channel is accessed 312. A determination is made if the current node (i.e. the relay server) has a parent server providing unicast data 314. If not, reception of the unicast data stream on the designate port for that channel is terminated 316 and the incoming multicast stream for that channel is received from the channel's multicast group 318.

If the relay server does have a parent server, incoming multicast stream traffic is terminated 320 and the incoming data stream for that channel is received as a unicast stream on the port designated for the channel 322. The received data for the channel is then re-multicast to the elements of the access network for the relay server 324.

A determination is made if the relay server has children for unicast transmission 326. If no child server is present, processing is directly returned to block 308 for the next channel. If a child server has been defined by the configuration server, the unicast stream received is transmitted to the port designated for that channel on each of the children for that relay server 328. Processing is then returned to block 308 for the next channel.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A system for live TV transmission over IP networks comprising:
a head end real-time encoding/transcoding server for converting live TV encoded data streams;
a first set of relay servers receiving multicast data streams from the encoding/transcoding server,
said first set of relay servers providing unicast stream output to a second set of relay servers through unicast only routers,
said first and second sets of relay routers providing unicast stream output to child relay routers and multicast stream output to associated access network elements.

2. A system for live TV transmission over IP networks as defined in claim 1 further comprising:
a third set of relay servers receiving said unicast stream output from said second set of relay servers and providing multicast stream output to associated network elements in the edge access network segment.

3. A system for live TV transmission over IP networks as defined in claim 1 wherein each of said first and second set of relay servers supply multicast stream output to a local access network.

4. A system for live TV transmission over IP networks as defined in claim 3 wherein each of said first, second and third sets of relay servers receives topology data on parent and child servers from a configuration server.

5. A system for live TV transmission over IP networks as defined in claim 3 wherein each of said first, second and third sets of relay servers receive for each channel multicast/unicast IP address and port information for TV streams from a configuration server.

6. A system for live TV transmission of IP networks as defined in claim 2 wherein the associated access network elements comprise Set-Top Boxes and content servers.

7. A system for live TV transmission of IP networks as defined in claim 2 wherein
at least one of the relay servers in the first set is in a different network tier than the remaining relay servers in the first set;
at least one of the relay servers in the second set is in a different network tier than the remaining relay servers in the second set;
and at least one of the relay servers in the third set is in a different network tier than the remaining relay servers in the third set.

8. A relay server for live TV transmission over IP networks comprising:
means for receiving multicast data streams from a head end;
means for receiving unicast data streams from a parent relay server;
means for multicast data stream output; and,
means for unicast data stream output.

9. A relay server for live TV transmission over IP networks as defined in claim 8 further comprising;
means for receiving topology data of parent and child relay servers from a configuration server.

10. A relay server for live TV transmission over IP networks as defined in claim 9 further comprising;
means for receiving for each channel multicast/unicast IP address and port information for TV streams from a configuration server.

11. A method for live TV transmission over IP networks comprising the steps of:
converting live TV encoded data streams in a head end real-time encoding/transcoding server;
receiving multicast data streams from the encoding/transcoding server in a first set of relay servers;
providing unicast stream output from said first set of relay servers to a second set of relay servers through unicast limited routers,
providing both unicast and multicast stream output from said first and second sets of relay servers.

12. A method for live TV transmission over IP networks as defined in claim 11 further comprising the steps of
receiving said unicast stream output from said second set of relay servers by a third set of relay servers and providing multicast stream output from said third set of relay servers.

13. A method for live TV transmission over IP networks as defined in claim 12 further comprising the step of receiving by each of said first, second and third sets of relay servers topology data on parent and child servers from a configuration server.

14. A method for live TV transmission over IP networks as defined in claim 12 further comprising the step of receiving on each of said first, second and third sets of relay servers channel and port information for TV streams from a configuration server.

15. A method for live TV transmission over IP networks as defined in claim 12 further comprising the step of supplying from each of said first and second set of relay servers multicast stream output to a local access network.
